(19) United States
(12) Patent Application Publication
(10) Pub. No.: US 2007/0102327 A1
(43) Pub. Date: May 10, 2007

(54) Sorting apparatus for the high voltages test of chip capacitors

(75) Inventors: Ming-Tsan Tseng, Tainan City (TW); Shin-Kan Liu, Taichung City (TW)

Correspondence Address: BIRCH STEWART KOLASCH & BIRCH, PO BOX 747, FALLS CHURCH, VA, 22040-0747, US

(73) Assignee: BOTH WING CO., LTD.

(21) Appl. No.: 11/311,326

(22) Filed: Dec. 20, 2005

(30) Foreign Application Priority Data
Nov. 10, 2005 (TW) 094139344

(51) Int. Cl. B07C 5/344

(52) U.S. Cl. 209/571

(57) ABSTRACT

The present invention discloses a sorting apparatus for the high voltage test of chip capacitors, which comprises: an align/position module, a sucker/transport module, a clamp/test module, and a diverter/store module, wherein the align/position module can simultaneously align multiple chip capacitors; the sucker/transport module can simultaneously suck the multiple chip capacitors and sends them to the clamp/test module for testing; and then, the diverter/store module can separate the chip capacitors according test results. In the present invention, in addition to that multiple chip capacitors can be tested simultaneously, the sucker/transport module can also simultaneously suck the next batch of chip capacitors ready for testing when the clamp/test module are testing the chip capacitors; therefore, the present invention can sort chip capacitors rapidly and promote the sort efficiency.

### FIELD OF THE INVENTION

The present invention relates to a sorting apparatus, particularly to a sorting apparatus for the high voltage test of chip capacitors.

### BACKGROUND OF THE INVENTION

Chip capacitors are important electronic elements, and after fabrication, they will be sorted by the high voltage test to insure that they can perform normally.

In the conventional sorting apparatuses, a feeder mechanism selects a single chip capacitor and sends it to a test device for testing, and according the test result, a diverter mechanism separates the qualified and unqualified chip capacitors into different containers; thus, the qualified chip capacitors are sorted out.

The conventional sorting apparatuses can only test and sort a single chip capacitor each time; therefore, owing to low sort speed, the conventional sorting apparatuses are inefficient and hard to meet users' requirement.

### SUMMARY OF THE INVENTION

The primary objective of the present invention is to provide a sorting apparatus for the high voltage test of chip capacitors, which can increase sort efficiency and promote the yield of sorting apparatuses to meet user's requirement.

The present invention proposes a sorting apparatus for the high voltage test of chip capacitors, which is used to sort chip capacitors and comprises: an align/position module, a sucker/transport module, a clamp/test module, and a diverter/store module. The align/position module aligns at least one chip capacitor to a specified direction and sends them to a specified position. The sucker/transport module uses at least one sucker sucks the chip capacitors and then uses at least one transport mechanism to transport them to the clamp/test module. The clamp/test module uses at least one pair of dampers and at least one actuation mechanism to clamp the chip capacitors and test them and output test results. The diverter module separates the chip capacitors according to the test results and stores them in different containers.

### BRIEF DESCRIPTION OF THE DRAWINGS

FIG. 1 is a diagram showing the perspective appearance of the present invention.

FIG. 2 is a diagram showing the right view of the feeder module of the present invention.

FIG. 3 is a diagram showing the front view of the align/position module of the present invention.

FIG. 4 is a diagram showing the right view of the sucker/transport module of the present invention.

FIG. 5 is a diagram schematically showing that the sucker/transport module sucks the chip capacitors according to the present invention.

FIG. 6 is a diagram showing the front view of the clamp/test module of the present invention.

FIG. 7 is a diagram schematically showing that the clamp/test module clamps the chip capacitors according to the present invention.

FIG. 8 is a diagram showing the front view of the diverter/store module of the present invention.

### DETAILED DESCRIPTION OF THE PREFERRED EMBODIMENTS

In order to clarify the objectives, characteristics, and efficacies of the present invention, the embodiments of the present invention are to be described below in detail in cooperation with the drawings.

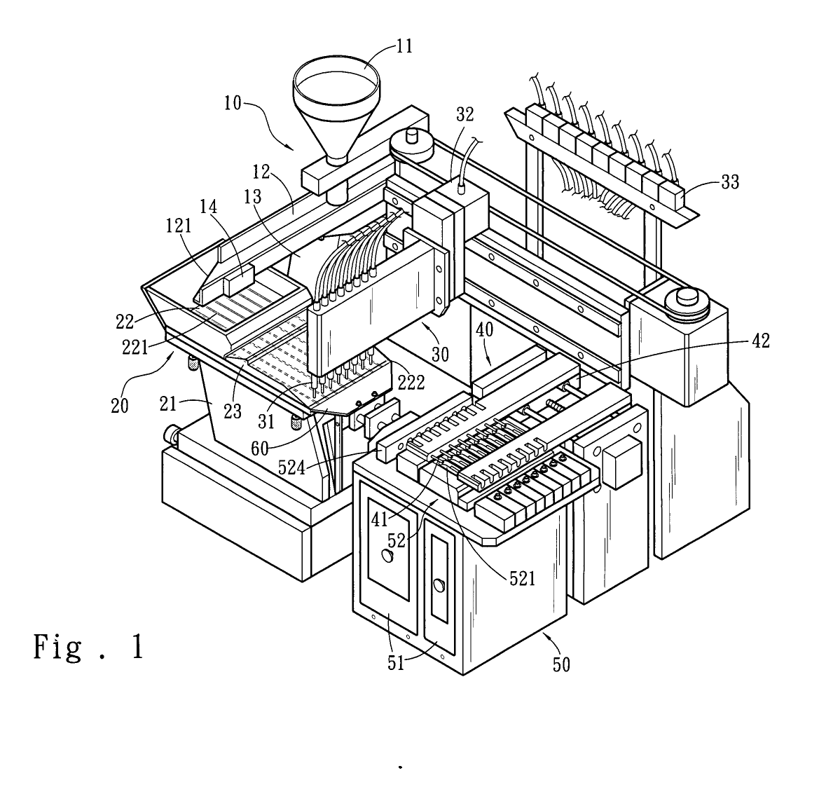

As shown in FIG. 1, the sorting apparatus for the high voltage test of chip capacitors 90 of the present invention comprises: a feeder module 10, an align/position module 20, a sucker/transport module 30, a clamp/test module 40, and a diverter/store module 50.

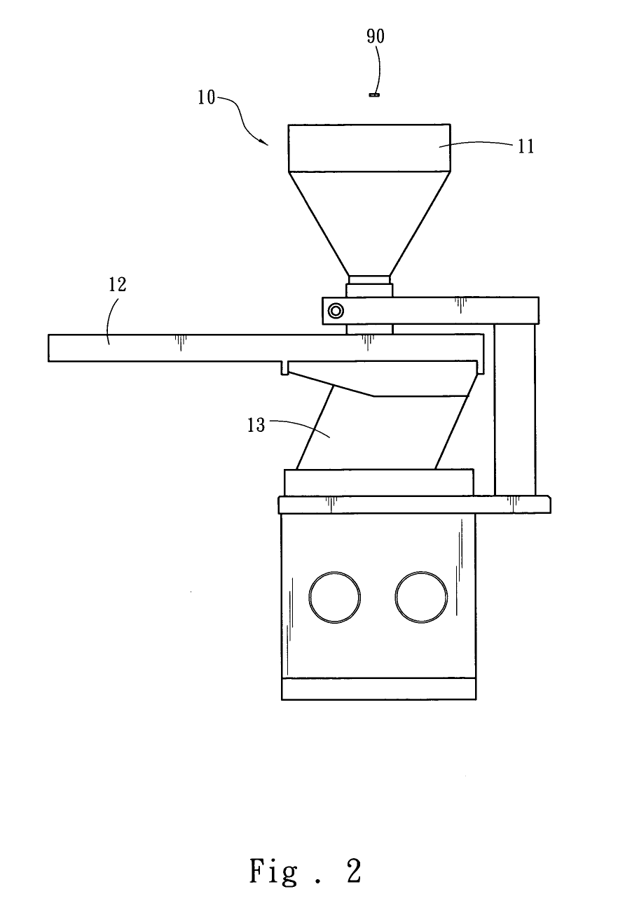

As shown in FIG. 2, the feeder module 10 has a funnel-like storage tank 11, a feeding chute 12, and a vibratory conveyer 13. The bottom of the storage tank 12 has an opening facing the feeding chute 12; the feeding chute 12 is installed above the vibratory conveyer 13; the end of the feeding chute 12 is positioned above the align/position module 20; thereby, the vibratory conveyer 13 utilizes vibratory motions to convey the chip capacitors 90 from the storage tank 11 via the feeding chute 12 to drop on the align/position module 20. The end 121 of the feeding chute 12 has a tilt angle with respect to the feeding chute 12 so that the chip capacitors 90 can evenly drop onto the align/position module 20. To avoid that too many chip capacitors 90 accumulate on the align/position module 20, a detector 14 is installed on the feeding chute 12 and above the align/position module 20, and the vibratory conveyer 13 will stop automatically when the chip capacitors 90 on the align/position module 20 are accumulated to a given height.

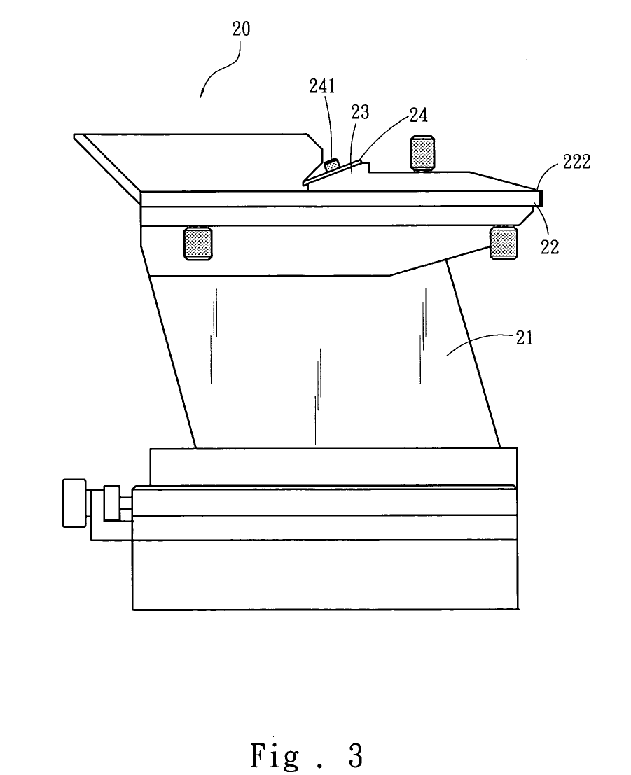

As shown in FIG. 3, the align/position module 20 aligns at least one chip capacitor 90 to a specified direction and sends them to a specified position. The align/position module 20 further comprises: a vibratory conveyer 21, an align platform 22 and a cover 23. The align platform 22 is installed above the vibratory conveyer 21 and has at least one align trench 221 on its surface. The vibratory motions of the vibratory conveyer 21 make the chip capacitors 90 drop into the align trenches 221 and then be aligned to a specified direction. The cover 23 is installed above and hoods the align platform 22 but exposes the side 222 of the align platform 22. The gap between the cover 23 and the align platform 22 is just enough to let a single chip capacitor 90, which is moved by vibration along the align trench 221, pass and then slide to the side 222 of the align platform 22, and the specified position mentioned above is exactly the side 222 of the align platform 22. An adjustable blocking plate 24 may be further installed above the align platform 22 and fixed to the cover 23 by screws 241. When the cross section of the chip capacitor 90 is a rectangle, the chip capacitor 90 can be enabled to enter into the cover 23 only with the longer side of the rectangle contacting the align platform 22 via adjusting the gap between the adjustable blocking plate 24 and the align platform 22; thereby, the align efficiency of the align platform 22 is promoted.

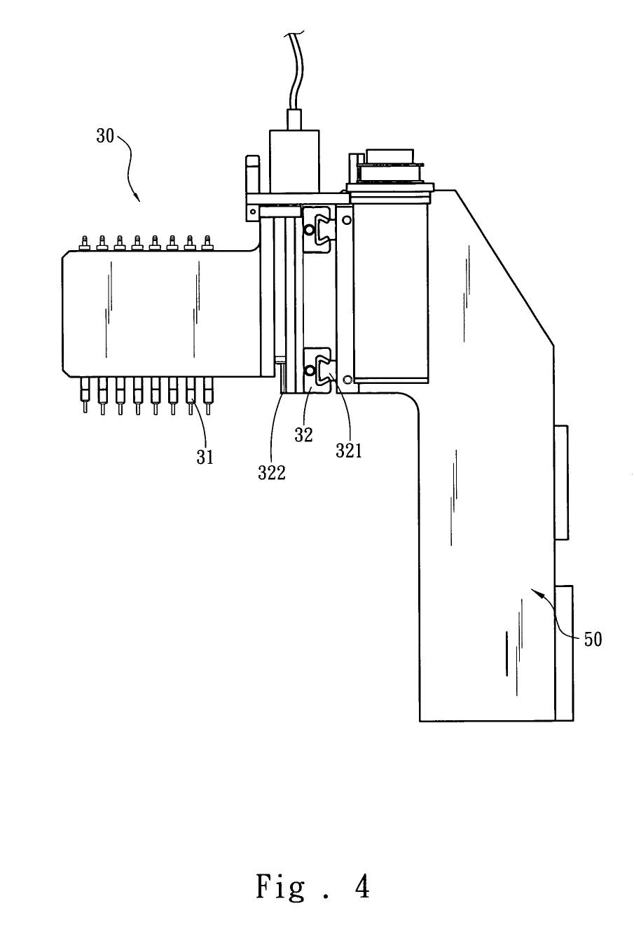

As shown in FIG. 4, the sucker/transport module 30 has at least one sucker 31 and at least one transport mechanism 32; the quantity of the suckers 31 is the same as that of the align trenches 221, and in this embodiment, there are eight suckers 31, but the number of the suckers 31 is not limit to eight in the present invention. The suckers 31 are installed on the transport mechanisms 32 and connected to a vacuum generator (not shown in the drawing), and a pressure detector 33, which is used to detect whether the chip capacitor 90 is sucked by the sucker 31, is installed between the sucker 31 and the vacuum generator. The transport mechanism 32 can move horizontally and vertically along a latitudinal slide rail 321 and a longitudinal slide rail 322.

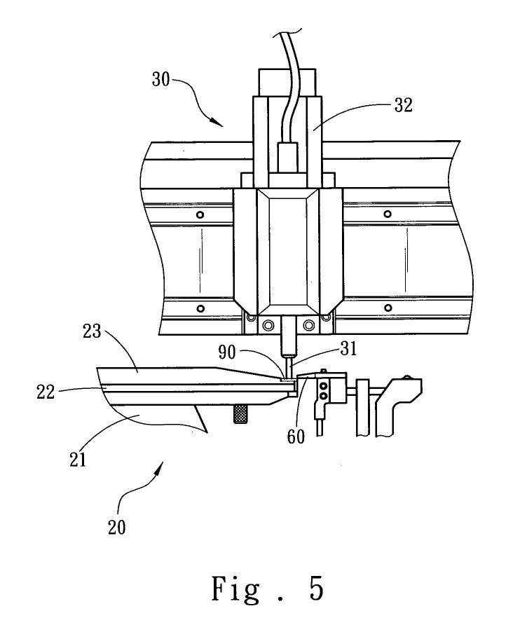

As shown in FIG. 5, when the chip capacitors 90 are moved by vibration along the align trenches 221 to the side 222 of the align platform 22, the transport mechanisms 32 will move the suckers 31 to contact and suck the chip capacitors 90, and the pressure detector 33 will detect whether the suckers 31 have sucked the chip capacitors 90. The present invention can further comprises a shield plate 60; when the chip capacitors 90 stay at the specified position, the shield plate 60 covers the chip capacitors 90, and when the suckers 31 intend to suck the chip capacitors 90, the shield plate 60 will translate to expose the chip capacitors 90; thereby, the chip capacitors 90 are less likely to fall from the align platform 22.

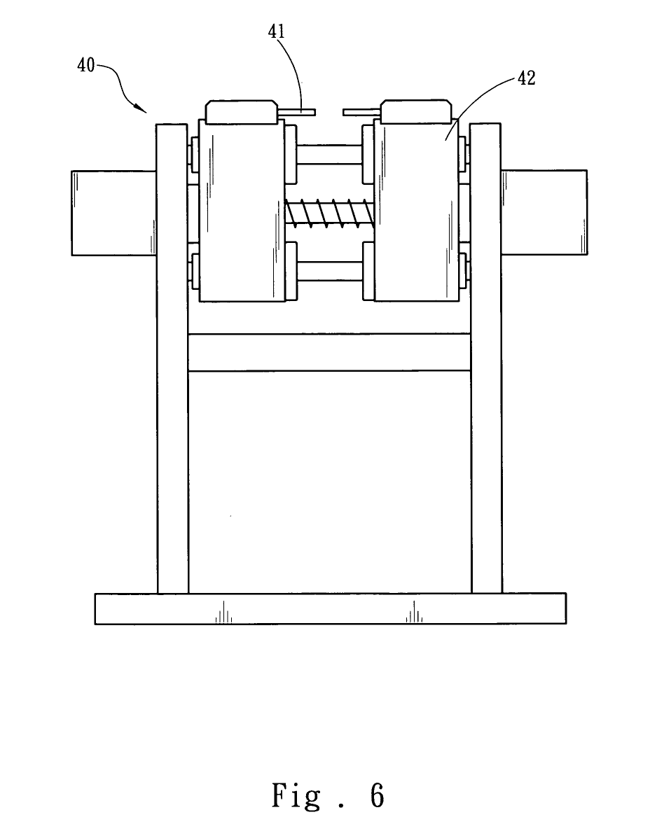

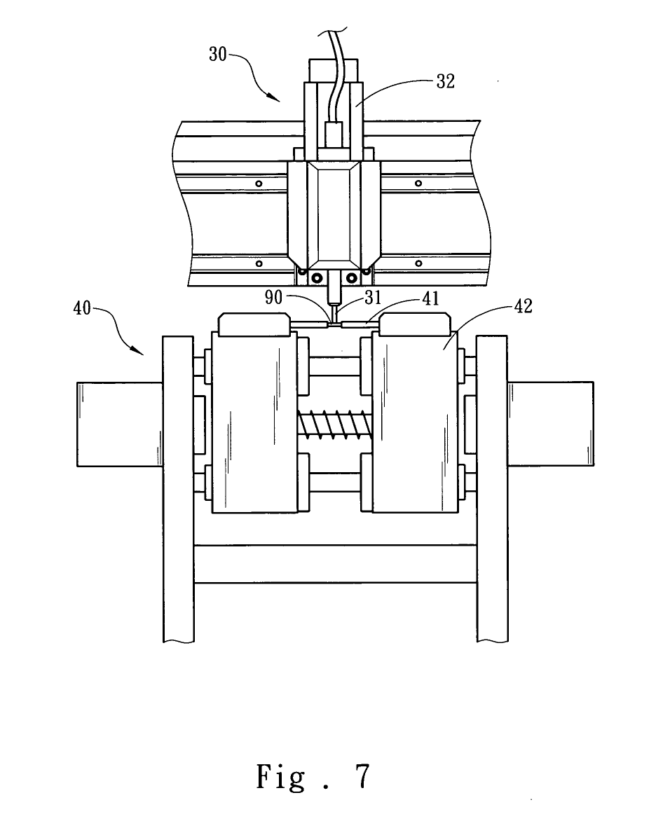

As shown in FIG. 6 and FIG. 7, the clamp/test module 40 has at least one pair of dampers 41, and the number of the pairs of dampers 41 is the same as the suckers 31. The dampers 41 are coupled to a high-voltage test equipment (not shown in the drawing) and are separately installed to both sides of an actuation mechanism 42. The suckers 31 suck the chip capacitors 90 from the specified position; next, the transport mechanisms 32 transport the chip capacitors 90 to the clamp/test module 40; and next, the actuation mechanisms 42 move the pairs of dampers 41 to clamp the chip capacitors 90, and then, the test equipments test the chip capacitors 90 and output test results.

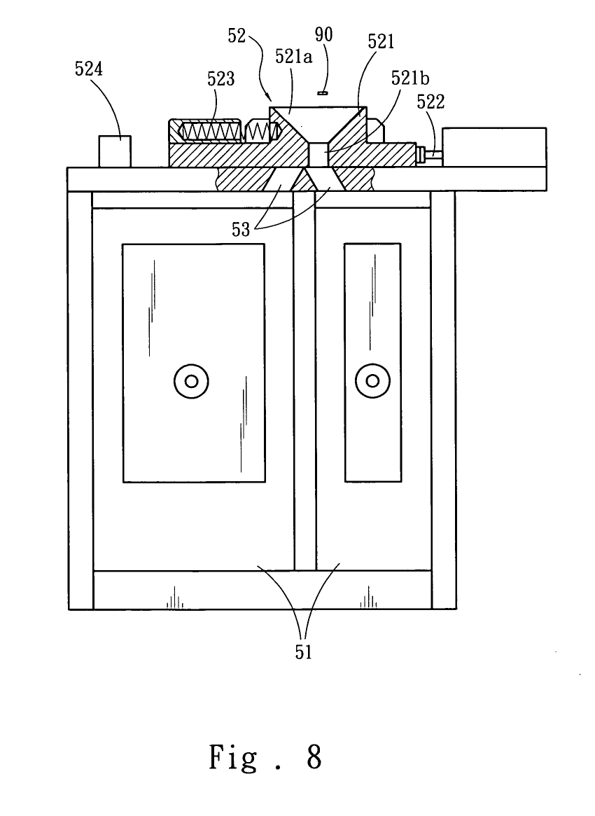

As shown in FIG. 8, the diverter/store module 50 has two containers 51 and at least one diverter mechanism 52, and the number of the diverter mechanisms 52 is the same as the pairs of dampers 41. The diverter mechanisms 52 are installed below the pairs of dampers 41. When the tests are completed, the pairs of dampers 41 release the chip capacitors 90, and the chip capacitors 90 fall into the diverter mechanisms 52, and then, the diverter mechanisms 52 will choose one of the containers 51 to receive the chip capacitors 90 respectively according to their test result. Thereby, the chip capacitors 90 are sorted.

The diverter mechanism 52 further comprises: a slide chute 521, a push rod 522 and a restore spring 523, and two containers 51 separately have their own inlets 53. The slide chute 521 has a receiving opening 521a and a bottom opening 521b. The push rod 522 and the restore spring 523 can drive the slide chute 521 to move horizontally above two containers 51 and between a normal position and an enable position. The bottom opening 521b will be exactly aligned to one of two inlets 53 when the slide chute 521 is at the normal position or the enable position. The receiving opening 521 can always receive the chip capacitors 90 dropping from the pairs of dampers 41 no matter whether the slide chute 521 is at the normal position or the enable position. The diverter mechanism 52 also has a sensor 524, which is used to detect whether the slide chute 521 is at the enable position and then determine whether the diverter mechanism 52 operates normally. In this embodiment, when the chip capacitor 90 passes the test, the push rod 522 will pushes the slide chute 521 to the enable position, and the qualified chip capacitor 90 is then collected in the left container 51, and meanwhile, the sensor 524 detects whether the slide chute 521 is at the enable position and determines whether the diverter mechanism 52 operates normally. When the chip capacitor 90 does not pass the test, or when the chip capacitor 90 has dropped for some unknown reason before the test, the slide chute 521 will stay at the normal position, and the chip capacitor will be collected into the right container 51 for a further examination. Thus, all the chip capacitors 90 collected in the left container 51 are indeed the qualified ones. As described above, the present invention can simultaneously test multiple chip capacitors; further, when the clamp/test module are testing the chip capacitors, the sucker/transport module can suck the next batch of chip capacitors ready for testing; therefore, the sort speed is increased, and the sort efficiency is also promoted, and users' requirement is then satisfied.

What is claimed is:

1. A sorting apparatus for the high voltage test of chip capacitors, used to sort chip capacitors, and comprising:
an align/position module, aligning at least one chip capacitor to a specified direction, and sending them to a specified position;
a sucker/transport module, having at least one sucker and at least one transport mechanism, wherein said suckers are respectively installed on said transport mechanisms and connected to a vacuum generator;
a clamp/test module, having at least one pair of clampers, which are separately installed to both sides of actuation mechanisms and are coupled to a high-voltage test equipment, wherein said suckers suck said chip capacitors from said specified position; next, said transport mechanisms transport said chip capacitors to said clamp/test module; and next, said actuation mechanisms move said pairs of dampers to clamp said chip capacitors, and then, said test equipments test said chip capacitors and output test results; and
a diverter/store module, having two containers and at least one diverter mechanism, which is installed below said pair of clampers, wherein when said tests are completed, said pairs of dampers release said chip capacitors, and said chip capacitors fall into said diverter mechanisms, and said diverter mechanisms will choose one of said containers to receive said chip capacitors respectively according to their test result, and thus, said chip capacitors are sorted.

2. The sorting apparatus for the high voltage test of chip capacitors according to claim 1, further comprising a feeder module, which further comprises: a funnel-like storage tank, a feeding chute, and a vibratory conveyer, wherein the bottom of said storage tank has an opening facing said feeding chute; said feeding chute is installed above said vibratory conveyer; the end of said feeding chute is positioned above said align/position module; and said vibratory conveyer utilizes vibratory motions to convey said chip capacitors from said storage tank via said feeding chute to drop on said align/position module.

3. The sorting apparatus for the high voltage test of chip capacitors according to claim 2, wherein the end of said feeding chute has a tilt angle with respect to said feeding chute.

4. The sorting apparatus for the high voltage test of chip capacitors according to claim 2, wherein said feeding chute has a detector positioned above said align/position module.

5. The sorting apparatus for the high voltage test of chip capacitors according to claim 1, wherein said align/position module further comprises: a vibratory conveyer, an align platform and a cover; said align platform is installed above said vibratory conveyer and has at least one align trench; the vibratory motions of said vibratory conveyer make said chip capacitors drop into said align trenches and then be aligned to said specified direction; said cover is installed above said align platform and hoods said align platform but exposes the side of said align platform; the gap between said cover and said align platform is just enough to let a single said chip capacitor, which is moved by vibration along said align trench, pass and slide to said side of said align platform, and said specified position is exactly said side of said align platform.

6. The sorting apparatus for the high voltage test of chip capacitors according to claim 5, further comprising a shield plate, wherein when said chip capacitors stay at said specified position, said shield plate will cover said chip capacitors, and when said suckers intend to suck said chip capacitors, said shield plate will translate to expose said chip capacitors.

7. The sorting apparatus for the high voltage test of chip capacitors according to claim 5, wherein an adjustable blocking plate is installed above said align platform and fixed to said cover by screws, and said adjustable blocking plate is used to adjust the passage gap for said chip capacitors between said align platform and said adjustable blocking plate.

8. The sorting apparatus for the high voltage test of chip capacitors according to claim 1, wherein a pressure detector is installed between said sucker and said vacuum generator and is used to detect whether said sucker has sucked said chip capacitor.

9. The sorting apparatus for the high voltage test of chip capacitors according to claim 1, wherein said transport mechanism has a latitudinal slide rail and a longitudinal slide rail, and said transport mechanism can move horizontally and vertically along said latitudinal slide rail and said longitudinal slide rail.

10. The sorting apparatus for the high voltage test of chip capacitors according to claim 1, wherein said diverter mechanism further comprises: a slide chute, a push rod and a restore spring; said two containers separately have their own inlets; said slide chute has a receiving opening and a bottom opening; said push rod and said restore spring can drive said slide chute to move horizontally above said two containers and between a normal position and an enable position; said bottom opening will be exactly aligned to one of two said inlets when said slide chute is at said normal position or said enable position; said receiving opening can always receive said chip capacitors dropping from said pairs of dampers no matter whether said slide chute is at said normal position or said enable position.

11. The sorting apparatus for the high voltage test of chip capacitors according to claim 10, wherein said diverter mechanism further has a sensor, which is used to detect whether said slide chute is at said enable position.
